(19) United States
(12) Patent Application Publication
(10) Pub. No.: US 2017/0083673 A1
(43) Pub. Date: Mar. 23, 2017

(54) SYSTEMS AND METHODS FOR ESTIMATING LIFECARE SERVICE COSTS

(71) Applicant: Thomas J. DAWSON, III, Silver Spring, MD (US)

(72) Inventor: Thomas J. DAWSON, III, Silver Spring, MD (US)

(21) Appl. No.: 15/269,303

(22) Filed: Sep. 19, 2016

Related U.S. Application Data
(60) Provisional application No. 62/219,987, filed on Sep. 17, 2015.

(51) Int. Cl. G06F 19/00

(52) U.S. Cl. CPC G06F 19/328; G06F 19/322

(57) ABSTRACT

Systems and methods for automatically determining estimated healthcare costs associated with an individual in a multi jurisdiction environment are described and may include providing a client with a first input interface configured to allow a service provider to create a record for the individual including a diagnosis code and a procedure code associated with a medical condition of the individual. A database, managed by the service provider, including a plurality of historical healthcare cost estimates associated with individuals in different jurisdictions may also be included. A network interface and/or a second input interface may be configured to receive information about the individual from the client, such as documents that are stored by the system in association with the record for the individual.

### RELATED APPLICATIONS

This application claims priority to U.S. Provisional Application No. 62/219,987, filed Sep. 17, 2015, the entire contents of which are hereby incorporated by reference.

### BACKGROUND OF THE INVENTION

Estimating the cost of health care, and related expenses, over periods of time up to and including an individual's expected lifespan can be important in a number of situations, particularly in the context of personal injury lawsuits in which damages may include such costs.

Traditionally, these estimates have varied wildly, even between experts in the field, and have been based primarily on estimates for actual services, which can be difficult to predict in the aggregate over an extended period of time. For example, a severely injured individual may be expected to require hundreds of separate treatments over a period of years, at least some of which may not prove necessary, depending on treatment outcomes, etc. The costs of any number of such treatments may also rise or fall, depending on myriad factors, over years or decades that the individual may require treatment.

Another factor that has historically complicated such estimates are multi jurisdictional issues related to health care costs, insurance, and availability and management of public programs. In the US, medical insurance has been left primarily in the realm of the states. In this regard, states have traditionally defined their relationships with carriers, the limitations on insurance programs, as well as how specific conditions and procedures may be handled, even (to some extent) with respect federally sponsored programs such as Medicaid. The complications inherent in the varied application of state regulations have been but one challenge in providing accurate and efficient health care cost estimates on a wide and repeatable basis in the U.S.

Accurate estimates for such costs have significant independent value not only in avoiding excessive or insufficient damage awards to injured plaintiffs, but also to an aging population, private entities and public institutions looking to prepare for future costs.

Accordingly, there exist ongoing needs to provide automated estimates for health care costs that are more accurate, verifiable and efficient than those provided using conventional methods.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

The inventor of the present subject matter has developed systems and methods that provide significant improvements in the area of health cost estimates, particularly in multi-jurisdiction environments such as the U.S. health care market. The present subject matter provides, among other objects, systems and methods that may acquire and assess the coverage available under a variety of health care plans, particularly under the “guaranteed issue” provisions of the Affordable Care Act (ACA), and that may determine and include the expected costs for specific procedures under specific identifiable circumstances in which identified federal, state and/or private health care plans are unavailable.

According to first aspects of the invention, systems for automatically determining estimated healthcare costs associated with an individual in a multi jurisdiction environment may include one or more of a first input interface configured to allow a service provider to create a record for the individual including a diagnosis code and a procedure code associated with a medical condition of the individual; a database managed by the service provider including a plurality of historical healthcare cost estimates associated with individuals in different jurisdictions; a network interface; and/or a second input interface that is served to a client via the network interface, and that is configured to receive information about the individual from the client. In embodiments, the information may include a plurality of documents that are stored by the system in association with the record for the individual.

Exemplary systems may also include a processor configured to determine whether the individual is eligible for a public health care plan based at least in part on the information from the client; identify a second health care plan that the individual is eligible for based at least in part on the information from the client, jurisdiction-specific rules associated with a domicile of the individual, and results of the determination of whether the individual is eligible for the public health care plan; retrieve plan information associated with the second health care plan; calculate an estimated healthcare cost for the individual over a period of time based at least in part on the plan information associated with the second health care plan, and one or more of the historical healthcare cost estimates; and/or generate a report including the estimated healthcare cost for the individual over the period of time.

In embodiments, the information about the individual may include a life care plan, and calculating the estimated healthcare cost for the individual over the period of time may include comparing services included in the life care plan to services available under the second health care plan and the public health care plan.

In embodiments, the public health care plan may be at least one of a Medicaid program, a Medicare program, a state health program, a Department of Veterans Affairs program, an Individuals With Disabilities Act program, a Public Disability program, or a Department of Education health program, and the second health care plan may be an ACA health care plan.

In embodiments, the system may be configured to identify the ACA health care plan from among a plurality of different level ACA health care plans that the individual is eligible for, and identifying the ACA health care plan may include comparing services that are available under the different level ACA health care plans in the jurisdiction of the individual's domicile, to services that are available under Medicaid in the jurisdiction of the individual's domicile.

In embodiments, creating the record for the individual may include automatically identifying the relevant jurisdiction of the individual's domicile.

In embodiments, the processor may be further configured to determine whether the individual has private third party insurance available, and calculating the estimated healthcare cost for the individual may be further based at least in part on whether the individual has private third party insurance available.

In embodiments, identifying the second health care plan may be based at least in part on demographic information associated with the individual.

In embodiments, at least one of the documents may be a medical record, and at least one of the diagnosis code and the procedure code are determined based on the medical record.

In embodiments, calculating the estimated healthcare cost for the individual may be further based on durable goods not covered by the public health care plan or the second health care plan.

In embodiments, calculating the estimated healthcare cost for the individual may further include obtaining health care provider reporting data including medical service costs, and estimating a cost for an expected medical service based on the reporting data.

According to further aspects of the invention, a computer-implemented method for automatically determining estimated healthcare costs associated with an individual in a multi-jurisdiction environment may include serving an input interface to a client via a network connection; receiving, via the input interface, information about the individual from the client, the information including a plurality of documents; storing the plurality of documents in association with the individual in a database; creating a record for the individual in the database, the record including a diagnosis code and a procedure code associated with a medical condition of the individual; determining whether the individual is eligible for at least one of a public health care plan or private third party insurance based at least in part on the information from the client; identifying a second health care plan that the individual is eligible for based at least in part on the information from the client, jurisdiction-specific rules associated with a domicile of the individual, and results of the determination of whether the individual is eligible for the public health care plan or the private third party insurance; retrieving plan information associated with the second health care plan; calculating an estimated healthcare cost for the individual over a period of time based at least in part on the plan information associated with the second health care plan, durable goods not covered by the second health care plan, the public health care plan or the private third party insurance, and one or more historical healthcare cost estimates generated by the service provider; and/or generating a report including the estimated healthcare cost for the individual over the period of time.

In embodiments, the information about the individual may include a life care plan, and calculating the estimated healthcare cost for the individual over the period of time may include comparing services included in the life care plan to services available under the second health care plan, and the public health care plan or the private third party insurance.

In embodiments, the second health care plan may be identified from among a plurality of different level ACA health care plans that the individual is eligible for, and identifying the second health care plan may include comparing services that are available under the different level ACA health care plans in the jurisdiction of the individual's domicile, to services that are available under Medicaid in the jurisdiction of the individual's domicile or under the private third party insurance.

In embodiments, creating the record for the individual may include automatically identifying the relevant jurisdiction of the individual's domicile.

Embodiments may also include determining whether a secondary payer rule, or other 3rd party liability rule, applies to the individual, and wherein calculating the estimated healthcare cost for the individual may be further based at least in part on whether the secondary payer rule, or other 3rd party liability rule, applies to the individual.

In embodiments, the estimated healthcare cost for the individual may be further based at least in part on whether the individual has private third party insurance available.

In embodiments, identifying the second health care plan may be based at least in part on demographic information associated with the individual.

In embodiments, the information about the individual may include at least two of a deposition transcript, a health record of the individual, a life care plan for the individual, and an economist report.

Embodiments may also include retrieving at least one of state insurance regulations or state healthcare regulations based on the individual's domicile, and at least one of identifying the second health care plan or calculating the estimated healthcare cost for the individual may be based at least in part on the state insurance regulations or the state healthcare regulations.

According to further aspects of the invention, computer-implemented methods for automatically determining estimated healthcare costs associated with an individual in a multi-jurisdiction environment may include serving an input interface to a client via a network connection; receiving, via the input interface, information about the individual from the client, the information including a plurality of documents; storing the plurality of documents in association with the individual in a database; creating a record for the individual in the database, the record including a diagnosis code and a procedure code associated with a medical condition of the individual; determining whether the individual is eligible for at least one of a public health care plan or private third party insurance based at least in part on the information from the client; identifying a second health care plan that the individual is eligible for based at least in part on the information from the client, jurisdiction-specific rules associated with a domicile of the individual, and results of the determination of whether the individual is eligible for the public health care plan or private third party insurance; retrieving plan information associated with the second health care plan; calculating an estimated healthcare cost for the individual over a period of time based at least in part on the plan information associated with the second health care plan, and one or more historical healthcare cost estimates generated by the service provider; and/or generating a report including the estimated healthcare cost for the individual over the period of time.

According to further aspects of the invention, computer-implemented methods and/or computer-readable storage medium may be provided including executable code for configuring a computer processor to perform any of the processes described herein.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention claimed. The detailed description and the specific examples, however, indicate only preferred embodiments of the invention. Various changes and modifications within the spirit and scope of the invention will become apparent to those skilled in the art from this detailed description.

For a fuller understanding of the nature and advantages of the present invention, reference should be made to the ensuing detailed description and accompanying drawings.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and various ways in which it may be practiced. In the drawings:

FIG. 1 depicts an exemplary environment including a networked life care plan and health care cost estimating system according to aspects of the invention.

FIGS. 2-4 show an exemplary process for providing a life care plan and cost estimate according to aspects of the invention.

FIG. 5 shows an interface for exchanging information between a client and a server application according to aspects of the invention.

### DETAILED DESCRIPTION OF THE INVENTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

It is understood that the invention is not limited to the particular methodology, protocols, etc., described herein, as these may vary as the skilled artisan will recognize. It is also to be understood that the terminology used herein is used for the purpose of describing particular embodiments only, and is not intended to limit the scope of the invention. It also is to be noted that as used herein and in the appended claims, the singular forms “a,” “an,” and “the” include the plural reference unless the context clearly dictates otherwise. Thus, for example, a reference to “a processor” is a reference to one or more processors and equivalents thereof known to those skilled in the art.

Unless defined otherwise, all technical terms used herein have the same meanings as commonly understood by one of ordinary skill in the art to which the invention pertains. The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals reference similar parts throughout the several views of the drawings.

Some or all of the processes described herein, or variations and/or combinations thereof, may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

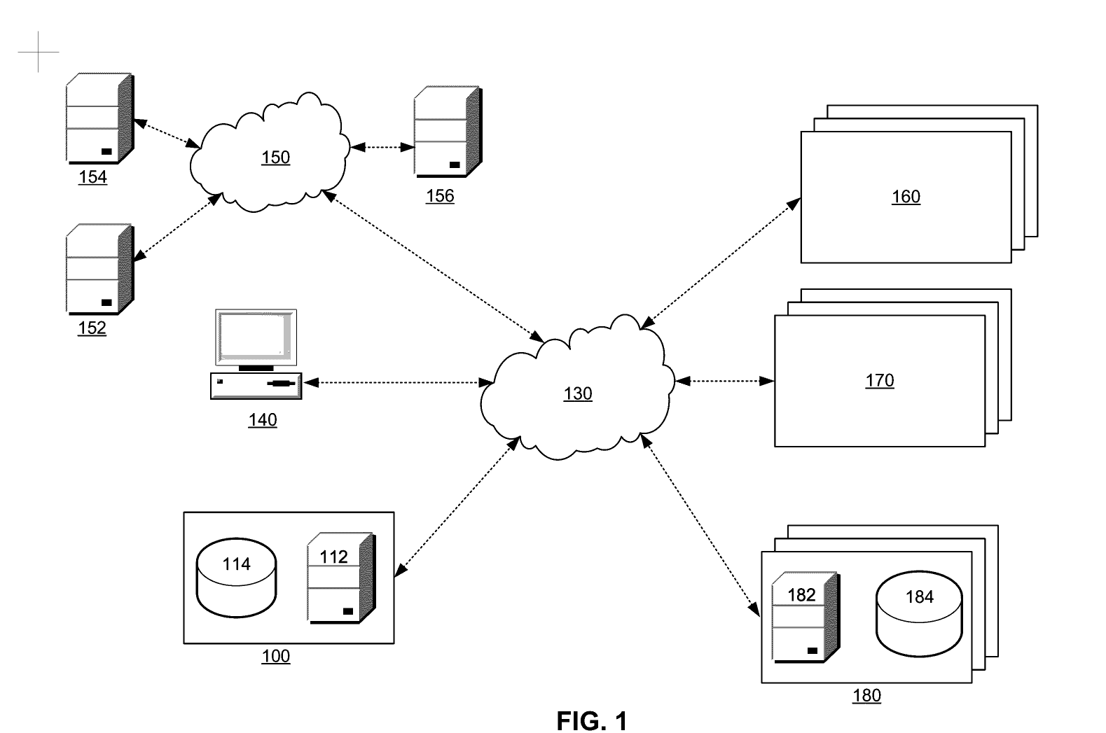

FIG. 1 depicts an exemplary environment including a networked life care plan and health care cost estimating system 100 according to aspects of the invention. As shown in FIG. 1, system 100 may include dedicated server(s) 112 and database(s) 114. However, it should also be noted that the system 100 may be implemented on any number of distributed computing resources, including cloud-based servers, databases, and the like. As described further herein, the system 100 may typically include one or more input/output interfaces that allow a service provider to exchange information via the Internet 130 (or other network) with various entities, such as individual clients using computing devices such as 140, or larger entities (e.g., medical service providers, etc.) such as shown by LAN 150 with various computer/servers 152-156. The system may also be configured to retrieve information from various resources related to, for example, individual state law/regulatory resources 160, federal law/regulatory resources 170 and/or health care provider resources 180. In some embodiments, the health care provider resources 180 may include servers 182 and/or databases 184 that include reporting information related to the provisioning of health care services. Such information can be automatically retrieved on a routine or as needed basis by the system 100 in order to better estimate the costs of particular services, in particular geographic regions and/or under certain public and/or private health care plans and/or networks. For example, records from a specific geographic region, medical provider, and/or insurance provider may be automatically identified as relevant to a new client, and may be utilized to populate various automated fields related to cost, treatment, coverages, etc. for the new client, using various methodologies described herein.

As also described further herein, the system 100 may be configured to respond to requests from client devices, and to provide a web page or other application by which clients can request health care plan estimates according to aspects of the invention. In some examples, such functionality may be incorporated in a program that can be licensed for direct use by individual clients. However, in those situations, there may still be instances where a client-side program may be configured to access proprietary information compiled and/or calculated by the service provider system 100.

The system 100 may be configured to create a record for an individual based on information received from client 140 and/or any other entity. In some examples, the record may include a diagnosis code and/or a procedure code associated with a medical condition of the individual. These codes may be automatically determined in a variety of ways, such as by reading the codes directly from electronic health records, scanning the codes from other electronic documents, associating the codes with other text, etc. Automated systems according to aspects of the invention may also be able to determine procedures that are appropriate for the individual based on a comparison of information received and machine learning or other algorithms that recognize treatment trends associated with a particular condition, demographic group, geographical region, health care program(s), or any other related information.

Exemplary database(s) 114 may be managed by a service provider associated with system 100, and may include the individual records discussed above, as well as a plurality of historical healthcare cost estimates associated with individuals in different jurisdictions, in different demographic groups, under different health care plans, etc.

The system 100 may include a network interface (not shown) and/or a second input interface that is served to client 140 (e.g., as a web page or application) via the network interface. The network interface may be configured to receive information about individuals from the client 140, or other entity, including network 150, and to store the information in database(s) 114.

The server 112 may include a processor configured to determine whether an individual is eligible for a public health care plan based at least in part on the information from the client 140 (e.g., demographic information, medical information, geographic location, etc.). Typically, this will include retrieving and/or analyzing public health care plan information from one or more state law/regulatory resources 160 and/or federal law/regulatory resources 170. For example, depending on the applicable rules, the system 100 may first determine whether the individual is eligible for a federal health care program and, depending on the results, determine whether the individual is eligible for one or more state-managed health care programs. Such determinations may be based on myriad factors that are provided directly from client(s) 140 and/or automatically determined by the system 100. For example, different states may have different rules that define coverage eligibility related to a given condition. According to aspects of the invention, the system 100 may be configured to determine eligibility for the individual (e.g., based on medical condition, necessary treatment, demographic information, etc.) in one or more different jurisdictions with different government health care plan coverage rules. Specific government health care plans that the system 100 may be configured to determine eligibility for may include Medicare, Medicaid, state-specific health care plans, among others.

The server 112 may also be configured to identify other health care plans that an individual is eligible for based on, for example, information from the client 140 or other entity such as network 150, jurisdiction-specific rules associated with a domicile of the individual (which may typically be found in health care provider resources 180 and/or state law/regulatory resources 160), and/or results of the determination of whether the individual is eligible for the public health care plan. The server 112 may retrieve plan information associated with the second health care plan via the Internet 130 or other network. The second plan may include, for example, a Federal health care exchange, a state health care exchange, a private health care plan, etc.

The server 112 may also be configured to calculate an estimated healthcare cost for the individual over a period of time based on plan information associated with a government health care plan, a second health care plan, and one or more of the historical healthcare cost estimates stored in database 114. Historical records may be used in such calculations, for example, to better estimate the length of certain types of treatment, changes in costs over time, demographic-specific factors, etc. Through the use of automated methods, including in-depth review of myriad historical records and estimates of expected costs related to procedures, treatments, prescription drugs, durable goods/equipment, etc. related to various medical diagnoses and/or conditions, as well as the complexities of different, concurrent, and/or interrelated forms of coverage, second party payer, third party liability, etc., the present subject matter can provide health care estimates that cannot reasonably be achieved using any conventional methods.

The server 112 may also be configured to generate a report including the estimated healthcare cost for the individual over the period of time. In some examples, such reports may include healthcare costs under a state plan purchased through the state Exchange, healthcare costs under a state-specific Medicaid program, healthcare costs under one or more state-specific Medicaid waiver programs, healthcare costs for Medicare, or the healthcare costs assuming a given combination of the foregoing healthcare options, as well as out-of-pocket costs not covered by the foregoing healthcare options. The reports may be distributed to client 140 or other entity via a network, such as the Internet 130, as electronic documents or within a web page or application.

The present invention is well suited for use with a global computer communication network such as the Internet 130. However it can be appreciated that, as future technologies are created, various aspects of the invention may be practiced with these improved technologies, including but not limited to, automated health care and/or demographic-related information gathering and distribution, medical care standard setting, etc.

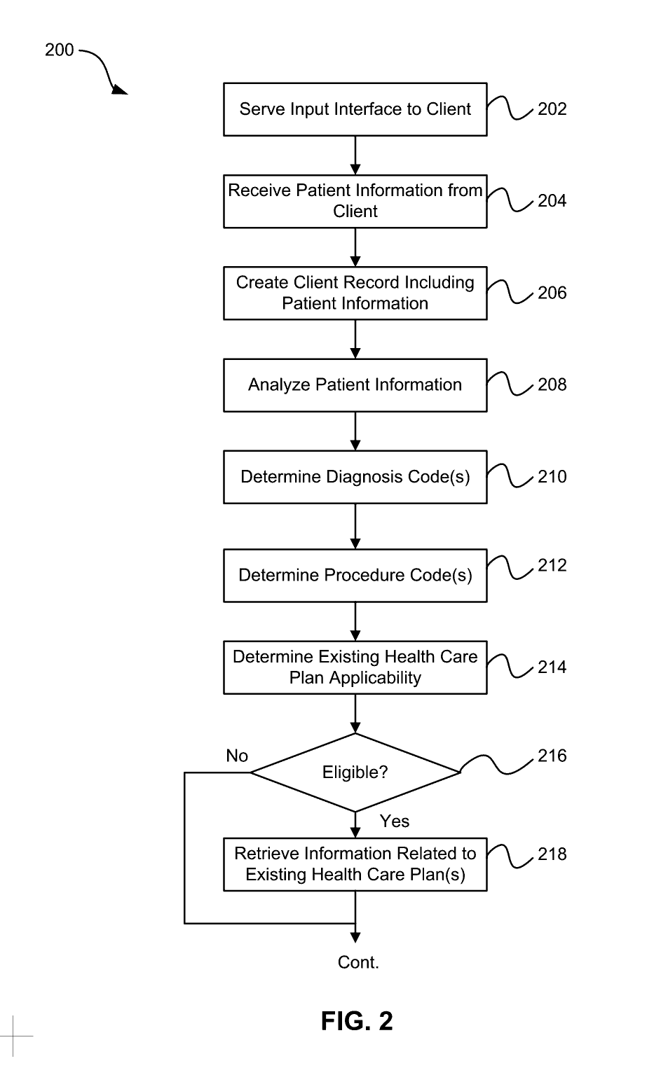

FIGS. 2-4 show an exemplary process 200 for providing a life care plan and cost estimate according to aspects of the invention. Each operation depicted therein may represent a sequence of operations that can be implemented in hardware or computer instructions implemented in hardware. In the context of computer instructions, the operations represent computer-executable instructions stored on one or more computer-readable storage media that, when executed by one or more physical processors, perform the recited operations. Generally, computer-executable instructions include routines, programs, objects, components, and the like that perform particular functions or implement particular data types. The order in which the operations are described is not intended to be construed as a limitation, and any number of the described operations can be duplicated, omitted, combined in any order and/or in parallel to implement the processes. Additionally, any specific reference to one or more operations being capable of being performed in a different order is not to be understood as suggesting that other operations may not be performed in another order.

The process 200 may begin with 202 in which an input interface may be served to a client device (e.g., a personal computer or other computing device such as a smart phone, etc.). In some examples, the input interface may be served in the context of a web browsing session (e.g., from a server to a client device over the Internet), via another web-based application, and/or locally (e.g., as proprietary/licensed software). The input interface may provide a user with the option to begin an information entry session related to a specific individual as part of a process for providing a health care estimate, and/or as part of another process such as an insurance or health care management process. For example, although the present subject matter has utility as a stand-alone product for generating health care cost estimates, it also may find applicability when integrated with other processes, including government and private insurance programs that want to project what the expected costs for individuals over time will be. This can be particularly helpful in the context of private insurance companies that need to accurately predict expected costs over time in order to set rates, manage resources, etc.

The process may optionally continue with 204, in which information, such as patient information may be received from the client via the input interface. This may include a variety of personal, demographic, diagnoses, treatment, and/or health care plan information that is entered directly (e.g., via a web page), electronic file transfers including electronic health and/or treatment records, and/or scanned or other electronic documents (e.g., .pdf scans of paper health and/or treatment records, etc.). This information may be stored in association with an identified patient/subject in 206 as part of a record used to generate an estimated health care costs over time.

The process may optionally continue with 208, in which the patient information is analyzed, e.g., using various scanning techniques, algorithms, filters, etc. In some examples, analysis of the patient information may be used to extract diagnosis and/or treatment/procedure codes from electronic health records, to scan codes from .pdf or other file types, and/or to infer appropriate diagnosis and/or treatment/procedure codes from other information. Additional information may be analyzed and/or inferred such as residence/domicile information, jurisdictional information, existing health care coverage, demographic information, etc.

The process may optionally continue with 210, in which one or more diagnosis code is determined. As mentioned previously, this may include extracting diagnosis codes from electronic health records, scanning codes from .pdf or other file types, and/or to inferring appropriate diagnosis codes from other information, such as symptoms, family history, other related diagnoses, geographical information, demographics, etc.

The process may optionally continue with 212, in which one or more treatment/procedure code is determined. This may include extracting treatment/procedure codes from electronic health records, scanning codes from .pdf or other file types, and/or to inferring appropriate treatment/procedure codes from other information, such as diagnoses, allergies, health care plan information, symptoms, family history, other related diagnoses and/or treatments/procedures, geographical information, etc. In some examples, necessary durable goods may also be determined using similar techniques, e.g., based on diagnosis codes, disabilities, treatment regimes, etc.

The process may optionally continue with 214, in which existing health care plan applicability may be determined. This may be based on, for example, insurance information provided by the client, information extracted from electronic health records, information scanned from .pdf or other file types, searching other databases (such as private or public health care databases), and/or inferring applicable coverage from other information such as military or other government/public service, private employer and/or retirement information, etc.

The process may optionally continue with 216, in which a determination is made regarding whether the individual is currently eligible to receive benefits from any existing health care plan identified in 214. If the individual is qualified, the flow may continue with 218, in which details of the applicable plan(s) may be retrieved, e.g., from public or private information resources such as websites, databases, from a proprietary database of the service provider, etc. If the individual is not currently eligible for benefits under any identified plans, the process 200 may skip 218, and proceed without such information.

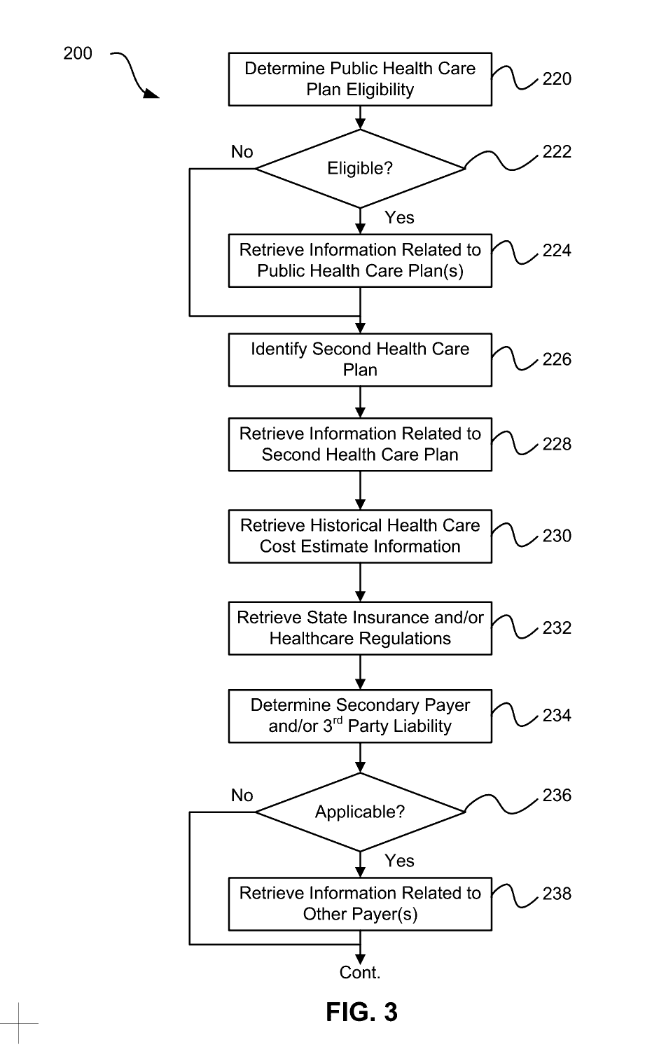

The process 200 may continue with 220 in FIG. 3. In 220, eligibility for a public health care plan may be determined. This may include, for example, a Medicaid program, a Medicare program, a state health program, a Department of Veterans Affairs program, an Individuals With Disabilities Act program, a Public Disability program, or a Department of Education health program, or other government-managed plans that may be provided to the public at reduced or no fee. Information from 204 (such as income, age, disabilities, diagnoses, treatment and/or procedures, etc.), as well as publically available information from various government resources may be used to determine the individual's eligibility for such programs. If the individual is qualified for a public health care plan identified in 220, the flow may continue with 224, in which details of the applicable public health care plan(s) may be retrieved, e.g., from public or private information resources such as websites, databases, from a proprietary database of the service provider, etc. It should also be noted that the system may take into account future coverage, such as coverage that becomes available at a certain age. For example, a person of limited financial means may qualify for one or more federal or state-provided health care plans when they reach a certain age. Therefore, the flow 200 may consider that eligibility and apply it to the appropriate portion of the life plan or cost estimate by applying date constraints or similar techniques. If the individual is not eligible for benefits under any identified plans, the process 200 may skip 224, and proceed without such information.

The process may optionally continue with 226, in which one or more other health care plans (referred to as “second plan(s)”) may be identified. In 226, eligibility for a health care insurance plan, such as an ACA-compliant plan, a federal health care exchange and/or a state health care exchange, may be determined. Many options may be available for a given individual depending on the market that they live in, and the system can include additional algorithms to sort through a plurality of available plans, e.g., based on factors such as cost, deductible, coverage, etc. In some examples, the client may be allowed to adjust the weighting applied to any of the factors considered by such algorithms. Information from 204 (such as residence/domicile, age, disabilities, diagnoses, treatment and/or procedures, etc.), as well as publically available information from various resources may be used to determine the individual's eligibility for such health care plans. If the individual is qualified for a second health care plan identified in 226 (which most if not all U.S. citizens should be under the ACA), the flow may continue with 228, in which details of the applicable second health care plan(s) may be retrieved, e.g., from public or private information resources such as websites, databases, from a proprietary database of the service provider, etc.

The process may optionally continue with 230, in which the service provider can retrieve historical health care cost estimate information. This can include, for example, proprietary reports that the service provider has previously generated (e.g., for similarly situated individuals, medical conditions, coverage and/or life plans, etc.), treatment and/or billing information that may be available from various medical service providers, federal or state regulatory agencies, etc. In some examples, the information retrieved in 230 may be automatically selected based on the information provided in 204, diagnosis codes determined in 210, procedure/treatment codes determined in 212, and/or any applicable plan information obtained in 218, 224 and/or 228.

The process may optionally continue with 232, in which state insurance and/or healthcare rules, regulations and/or laws may be retrieved. This information may be used, for example, in determining Medicaid waiver programs for which an individual might be eligible.

The process may optionally continue with 234, in which secondary payer and/or 3^{rd} party liability may be determined. These determinations may be based on many factors including coverage overlaps, state or federal laws or regulations, court decisions, contracts, etc. If secondary payer and/or 3^{rd} party liability is applicable, the flow may continue with 238, in which details of the applicable secondary payer and/or 3^{rd} party liability may be retrieved, e.g., from information provided by the client, court records, statutes, regulations, public or private information resources such as websites, databases, a proprietary database of the service provider, etc. If secondary payer and/or 3^{rd} party liability is not applicable, the process 200 may skip 238, and proceed without such information.

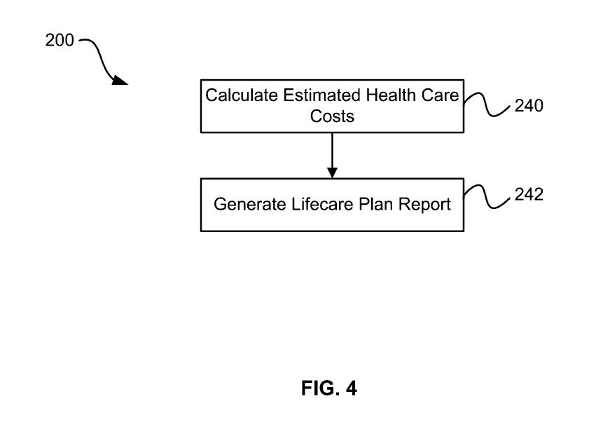

The continuation of process 200 is shown in FIG. 4. As shown in FIG. 4, the process may optionally continue with 240, in which estimated health care costs for the individual may be calculated. This can include consideration of the full range of information obtained in 204-238, including personal and demographic information, determined diagnoses, determined treatments/procedures, existing insurance coverage information, public health care plan information, second health care plan information, other payer information, etc. In some examples, algorithms may be configured to estimate an expected lifespan for the individual, and/or to compare expected costs between different available plans, and to determine an overall expected cost based on the lowest cost alternative for similar treatments over an expected lifespan. For example, certain expected procedure, device and/or drug coverage may be provided by a public health plan (which may be age limited) at reduced or no cost to the individual. Deductibles or other costs associated with an existing health care plan or a second health care plan may be calculated and compared to the public health care plan option (during a relevant span of years), and the public health care plan option may be selected based on overall expected cost. The process may also consider the cost of penalties that may apply, e.g., if the individual does not have an ACA-compliant health care plan, in determining the most cost-effective solution.

By way of further example, under current and expected law and regulation, an individual may have a medical condition that precludes them from continuing in their current job and employer-sponsored insurance plan. According to aspects of the present invention, information about the individual, their medical condition(s) and treatment plans, their existing insurance (including expected end dates based on state or other regulatory information), public health care plan options, and one or more ACA-compliant plans may be automatically evaluated and an overall estimated healthcare cost over a period of years may be generated. This is a fundamentally different process than has been achieved in the past, for several reasons, including the fact that many health issues made individuals uninsurable (requiring wildly speculative treatment cost estimates over time), myriad state regulations, and lack of complete, available and accurate treatment cost information.

The process may optionally continue with 242, in which a “lifecare plan” report may be generated (and stored for later reference and use in similar report calculations) including a comprehensive listing of determined medical diagnoses, treatments, medical services, durable goods, applicable public and private health care plans, and expected costs for the individual over a period of years.

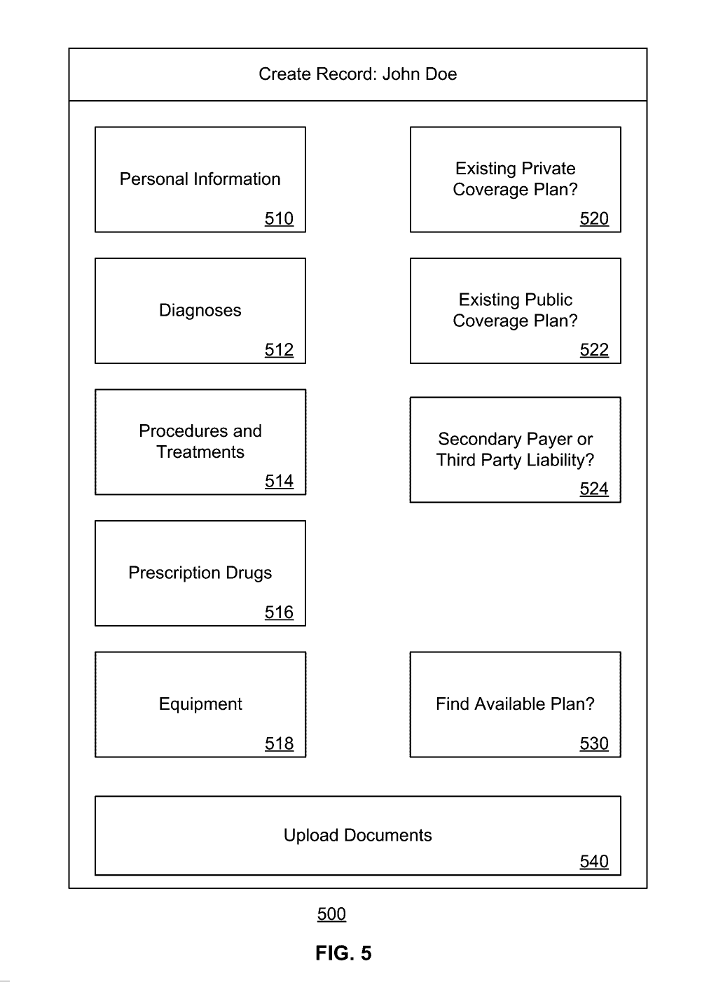

As shown in FIG. 5, an interface 500 may be provided by a cloud or network server, e.g., server 112 in FIG. 1, and presented to a user, e.g., client 140 shown in FIG. 1. Interface 500 may include various icons or fields for users to input or request information, such as personal information icon/field 510, diagnoses icon/field 512, procedures and treatments icon/field 514, prescription drugs icon/field 516, equipment icon/field 518. These icon/fields may be configured to allow the user to provide (or request the system to determine) various information relevant to the subjects, such as a “Personal Information” icon activating another interface (not shown) with fields for name, DOB, domicile, etc. In some examples, the server providing the interface 500 may be configured to determine and/or pre-load one or more options and/or elements related to the various icon/fields based on other information that has already been input by the user or otherwise determined by the server/system. For example, a user may input (or the server may scan or otherwise determine) a diagnoses code in Diagnoses field 512, and related procedures and/or treatments, prescription drugs, or equipment may be identified (and preloaded into fields 514-518) based on correspondence tables, other treatment records, or various other means such as those described herein. As discussed above, a client record record may include a diagnosis code and/or a procedure code associated with a medical condition of the individual. These codes may be automatically determined in a variety of ways, such as by reading the codes directly from electronic health records, scanning the codes from other electronic documents, associating the codes with other text, etc. Automated systems according to aspects of the invention may also be able to determine procedures that are appropriate for the individual based on a comparison of information received via interface 500, and machine learning or other algorithms that recognize treatment trends associated with a particular condition, demographic group, geographical region, health care program(s), or any other related information.

In some cases, the identification or inference of additional information realted to icon/fields may be definitive, or the preloaded possibilities may require final selection by the user to confirm. In any event the entry of such information is made easier since possible entries for various fields may be narrowed through reference to other input or otherwise obtained information. In some examples, an interface 500 may also be used by a service provider to review, revise, and finalize an estimate by reviewing the information that has been provided by a client, and allowing the service provider to modify or further refine the record.

As also shown in FIG. 5, interface 500 may include additional icons or fields for users to input or request information related to coverage plans or sources, such as existing private coverage plan icon/field 520, existing public coverage plan icon/field 522, secondary payer or third party liability icon/field 524, or find available plan icon/field 530. These icon/fields may be configured to allow the user to provide (or request the system to determine) various information relevant to the coverage that the user currently has, or may be entitled to, such as a “Existing Private Coverage Plan” icon activating another interface (not shown) with an input field, or list of possible private coverage plans for the user to select. Likewise, “Existing Public Coverage Plan” icon may activate another interface (not shown) with an input field, or list of possible public coverage plans for the user to select. A “Secondary Payer or Third Party Liability” icon may activate another interface (not shown) that allows the user to specify secondary payer or third party liability details that may be used to calculate estimates as described herein. Icon 524 may also be used to activate a review of judgment documents, state laws or other regulations that may be used to automatically determine or estimate the applicability or availability of secondary payer or third party liability for a given user/client. As with the icon/fields 510-518, the icon/fields 520-524 may be configured to determine and/or pre-load one or more options and/or elements related to the various icon/fields based on other information that has already been input by the user or otherwise determined by the server/system. For example, a user may input (or the server may scan or otherwise determine) a client name, age and domicile in Personal Information field 510, and related public coverage plans may be identified and preloaded into field 522 based on correspondence tables, applicable law and/or regulation, or various other means such as those described herein. In some cases, the identification may be definitive (such as public programs that the user is entitled to by operation of law or regulation), or the preloaded possibilities may require final selection by the user to confirm.

As also shown in FIG. 5, interface 500 may include additional icons for users to request information related to available coverage plans, such as find available plan icon 530. These icons may be configured to allow the user to request the system to determine, for example, available public and/or private medical coverage plans that the user/client may be entitled to receive or enroll in, and may provide multiple options for the user to select among. Typically, the icon 530 will initiate an operation on the server-side, whereby the information input and/or determined via interface 500 is compiled and analyzed in coordination with other commercial and/or governmental program information in order to identify available plans.

As also shown in FIG. 5, interface 500 may include additional icons 540 for users to upload documents to the system, such as uploading documents to database 114 in FIG. 1. These documents may be scanned by the system, e.g., server 100, and relevant information extracted for populating various fields such as those described herein, and/or for automatically determining and/or confirming additional information. For example, an insurance or government record may identify a particular plan that can be automatically verified by the system to ensure that the plan/coverage is still in effect, or that any such scanned information is otherwise genuine. In some examples, icon/fields such as those previously described may be adapted to notify a user when further input or user selection is required based on, for example, the results of automated scanning performed on uploaded documents and an analysis of other regulatory or other information. For example, the system may determine a majority of the information necessary to calculate a desired estimate based on automated document scans and related analysis, but may need the user to input or confirm some additional details based on a comparison of the extracted information and tables of necessary information for the given type of estimate, in which case certain of icons 510-524 may be highlighted or otherwise flagged to direct the user to input the required information, or select from preloaded options as previously described.

In some cases, when all of the necessary information is obtained, an additional icon may be presented, e.g., in order for the user or service provider to generate an estimate as variously described above.

In addition, embodiments of the present invention further include computer-readable storage media that include program instructions for performing various computer-implemented operations as described herein. The computer readable medium is any data storage device that can store data which can thereafter be read by a electronic system. The media may also include, alone or in combination with the program instructions, data files, data structures, tables, and the like. The media and program instructions may be those specially designed and constructed for the purposes of the present subject matter, or they may be of the kind available to those having skill in the computer software arts. Examples of computer-readable storage media include magnetic media such as flash drives, hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

The computer readable medium can also be distributed over a network coupled to electronic systems so that the computer readable code is stored and executed in a distributed fashion.

Other variations include, but are not limited to, variations on the hardware used to implement various embodiments of the present disclosure, as will be appreciated by those of skill in the art.

The description given above is merely illustrative and is not meant to be an exhaustive list of all possible embodiments, applications or modifications of the invention. Thus, various modifications and variations of the described methods and systems of the invention will be apparent to those skilled in the art without departing from the scope and spirit of the invention. Although the invention has been described in connection with specific embodiments, it should be understood that the invention as claimed should not be unduly limited to such specific embodiments.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

What is claimed is:

1. A system for automatically determining estimated healthcare costs associated with an individual in a multi jurisdiction environment, comprising:
a first input interface configured to allow a service provider to create a record for the individual including a diagnosis code and a procedure code associated with a medical condition of the individual;
a database managed by the service provider including a plurality of historical healthcare cost estimates associated with individuals in different jurisdictions;
a network interface;
a second input interface that is served to a client via the network interface, and that is configured to receive information about the individual from the client, the information including a plurality of documents that are stored by the system in association with the record for the individual; and
a processor configured to:
determine whether the individual is eligible for a public health care plan based at least in part on the information from the client;
identify a second health care plan that the individual is eligible for based at least in part on the information from the client, jurisdiction-specific rules associated with a domicile of the individual, and results of the determination of whether the individual is eligible for the public health care plan;
retrieve plan information associated with the second health care plan;
calculate an estimated healthcare cost for the individual over a period of time based at least in part on the plan information associated with the second health care plan, and one or more of the historical healthcare cost estimates; and
generate a report including the estimated healthcare cost for the individual over the period of time.

2. The system of claim 1, wherein the information about the individual includes a life care plan, and calculating the estimated healthcare cost for the individual over the period of time includes comparing services included in the life care plan to services available under the second health care plan and the public health care plan.

3. The system of claim 1, wherein the public health care plan is at least one of a Medicaid program, a Medicare program, a state health program, a Department of Veterans Affairs program, an Individuals With Disabilities Act program, a Public Disability program, or a Department of Education health program, and the second health care plan is an ACA health care plan.

4. The system of claim 3, wherein the system is configured to identify the ACA health care plan from among a plurality of different level ACA health care plans that the individual is eligible for, and identifying the ACA health care plan includes comparing services that are available under the different level ACA health care plans in the jurisdiction of the individual's domicile, to services that are available under Medicaid in the jurisdiction of the individual's domicile.

5. The system of claim 1, wherein creating the record for the individual includes automatically identifying the relevant jurisdiction of the individual's domicile.

6. The system of claim 1, wherein the processor is further configured to determine whether the individual has private third party insurance available, and calculating the estimated healthcare cost for the individual is further based at least in part on whether the individual has private third party insurance available.

7. The system of claim 1, wherein identifying the second health care plan is based at least in part on demographic information associated with the individual.

8. The system of claim 1, wherein at least one of the documents is a medical record, and at least one of the diagnosis code and the procedure code are determined based on the medical record.

9. The system of claim 1, wherein calculating the estimated healthcare cost for the individual is further based on durable goods not covered by the public health care plan or the second health care plan.

10. The system of claim 1, calculating the estimated healthcare cost for the individual further includes obtaining health care provider reporting data including medical service costs, and estimating a cost for an expected medical service based on the reporting data.

11. A computer-implemented method for automatically determining estimated healthcare costs associated with an individual in a multi jurisdiction environment, comprising:
serving an input interface to a client via a network connection;
receiving, via the input interface, information about the individual from the client, the information including a plurality of documents;
storing the plurality of documents in association with the individual in a database;
creating a record for the individual in the database, the record including a diagnosis code and a procedure code associated with a medical condition of the individual;
determining whether the individual is eligible for at least one of a public health care plan or private third party insurance based at least in part on the information from the client;
identifying a second health care plan that the individual is eligible for based at least in part on the information from the client, jurisdiction-specific rules associated with a domicile of the individual, and results of the determination of whether the individual is eligible for the public health care plan or the private third party insurance;
retrieving plan information associated with the second health care plan;
calculating an estimated healthcare cost for the individual over a period of time based at least in part on the plan information associated with the second health care plan, durable goods not covered by the second health care plan, the public health care plan or the private third party insurance, and one or more historical healthcare cost estimates generated by the service provider; and
generating a report including the estimated healthcare cost for the individual over the period of time.

12. The method of claim 11, wherein the information about the individual includes a life care plan, and calculating the estimated healthcare cost for the individual over the period of time includes comparing services included in the life care plan to services available under the second health care plan, and the public health care plan or the private third party insurance.

13. The method of claim 11, wherein the second health care plan is identified from among a plurality of different level ACA health care plans that the individual is eligible for, and identifying the second health care plan includes comparing services that are available under the different level ACA health care plans in the jurisdiction of the individual's domicile, to services that are available under Medicaid in the jurisdiction of the individual's domicile or under the private third party insurance.

14. The method of claim 11, wherein creating the record for the individual includes automatically identifying the relevant jurisdiction of the individual's domicile.

15. The method of claim 11, further comprising determining whether a secondary payer rule, or other 3^{rd} party liability rule, applies to the individual, and wherein calculating the estimated healthcare cost for the individual is further based at least in part on whether the secondary payer rule, or other 3^{rd} party liability rule, applies to the individual.

16. The method of claim 11, wherein the estimated healthcare cost for the individual is further based at least in part on whether the individual has private third party insurance available.

17. The method of claim 11, wherein identifying the second health care plan is based at least in part on demographic information associated with the individual.

18. The method of claim 11, wherein the information about the individual includes at least two of a deposition transcript, a health record of the individual, a life care plan for the individual, and an economist report.

19. The method of claim 11, further comprising retrieving at least one of state insurance regulations or state healthcare regulations based on the individual's domicile, wherein at least one of identifying the second health care plan or calculating the estimated healthcare cost for the individual is based at least in part on the state insurance regulations or the state healthcare regulations.

20. A computer-implemented method for automatically determining estimated healthcare costs associated with an individual in a multi jurisdiction environment, comprising:
serving an input interface to a client via a network connection;
receiving, via the input interface, information about the individual from the client, the information including a plurality of documents;
storing the plurality of documents in association with the individual in a database;
creating a record for the individual in the database, the record including a diagnosis code and a procedure code associated with a medical condition of the individual;
determining whether the individual is eligible for at least one of a public health care plan or private third party insurance based at least in part on the information from the client;
identifying a second health care plan that the individual is eligible for based at least in part on the information from the client, jurisdiction-specific rules associated with a domicile of the individual, and results of the determination of whether the individual is eligible for the public health care plan or private third party insurance;
retrieving plan information associated with the second health care plan;
calculating an estimated healthcare cost for the individual over a period of time based at least in part on the plan information associated with the second health care plan, and one or more historical healthcare cost estimates generated by the service provider; and
generating a report including the estimated healthcare cost for the individual over the period of time.
